(19) United States
(12) Patent Application Publication
(10) Pub. No.: US 2023/0211765 A1
(43) Pub. Date: Jul. 6, 2023

(54) BRAKING DEVICE

(71) Applicant: ADVICS CO., LTD., Kariya-shi, Aichi-ken (JP)

(72) Inventors: Tsuyoshi OTAKE, Kariya-shi, Aichi-ken (JP); Atsushi TAKAHASHI, Kariya-shi, Aichi-ken (JP)

(73) Assignee: ADVICS CO., LTD., Kariya-shi, Aichi-ken (JP)

(21) Appl. No.: 17/996,685

(22) PCT Filed: Apr. 29, 2021
(86) PCT No.: PCT/JP2021/017130

§ 371 Date: Oct. 20, 2022

(30) Foreign Application Priority Data
Apr. 30, 2020 (JP) 2020-080262

(51) Int. Cl. B60T 13/74; B60T 13/68; B60T 17/02; B60T 13/14; H02K 5/22; H02K 7/116; H02K 11/21

(52) U.S. Cl. CPC B60T 13/745; B60T 13/686; B60T 17/02; B60T 13/148; H02K 5/225; H02K 7/116; H02K 11/21; B60T 2270/88

(57) ABSTRACT

The braking device includes: a motor including a power terminal for power reception and being configured to adjust a braking force applied to a wheel in accordance with rotation of a rotary shaft; a substrate orthogonal to an extending direction of the power terminal and connected to the power terminal; and a housing provided at a position facing the substrate. The motor is provided between the housing and the substrate such that the power terminal faces the substrate, and is provided in the housing.

### TECHNICAL FIELD

The present disclosure relates to a braking device.

### BACKGROUND ART

For example, Japanese Patent No. 4355271 discloses a braking device that adjusts a braking force by a driving force of a motor. This device increases and decreases hydraulic pressure of a wheel cylinder by operating a pump by the motor. Further, in this device, a control unit of the motor and the motor are integrated using a housing. A hydraulic circuit including an electromagnetic valve and a pressure sensor is provided in the housing. The motor is disposed on one side of the housing, and a substrate (ECU substrate) is disposed on the other side of the housing.

### CITATION LIST

### Patent Literature

PTL 1: Japanese Patent No. 4355271

### SUMMARY

### Technical Problem

However, in a configuration of the device, in order to connect the motor and the substrate, it is necessary to form a through hole in the housing. Since the motor is connected to the substrate via the through hole, a motor harness for supplying power to the motor is long. The longer the motor harness is, the larger the power loss is, the more susceptible to noise the power is, and the worse workability of assembly becomes. Further, when the motor is provided with a rotation angle sensor, a sensor harness is also connected to the substrate via the through hole of the housing, and thus a length of the sensor harness is large. As described above, there is room for improvement in the braking device of the related art from a viewpoint of shortening a connection line between the motor and the substrate.

An object of the disclosure is to provide a braking device capable of shortening a connection line between a motor and a substrate and improving assembly workability.

### Solution to Problem

A braking device according to the disclosure includes: a motor including a power terminal for power reception and being configured to adjust a braking force applied to a wheel in accordance with rotation of a rotary shaft; a substrate orthogonal to an extending direction of the power terminal and connected to the power terminal; and a housing provided at a position facing the substrate. The motor is provided between the housing and the substrate such that the power terminal faces the substrate, and is provided in the housing.

### Advantageous Effects of Disclosure

According to the disclosure, the motor is provided in the housing in a manner of facing the substrate. Accordingly, the motor and the substrate can be connected to each other without forming a through hole for a harness in the housing. That is, since the power terminal and the substrate can be connected regardless of a size of the housing, a connection line between the motor and the substrate can be shortened. In addition, since the power terminal is connected to the substrate without passing through the through hole and the substrate is orthogonal to the power terminal, a connection configuration is simplified. Accordingly, assembly workability can be improved.

### BRIEF DESCRIPTION OF DRAWINGS

FIG. 1 is a configuration view (schematic cross-sectional view) of a braking device according to an embodiment.

FIG. 2 is a configuration diagram of the braking device according to the present embodiment.

FIG. 3 is a configuration view showing a modification of the braking device according to the present embodiment.

FIG. 4 is a schematic view showing a modification of the braking device according to the present embodiment.

FIG. 5 is a schematic view showing a modification of the braking device according to the present embodiment.

FIG. 6 is a schematic view showing a modification of the braking device according to the present embodiment.

### DESCRIPTION OF EMBODIMENTS

Hereinafter, an embodiment of the disclosure will be described with reference to the drawings. Drawings used in the description are schematic diagrams. In the present embodiment and modifications thereof, the same or equivalent parts are denoted by the same reference numerals in the drawings.

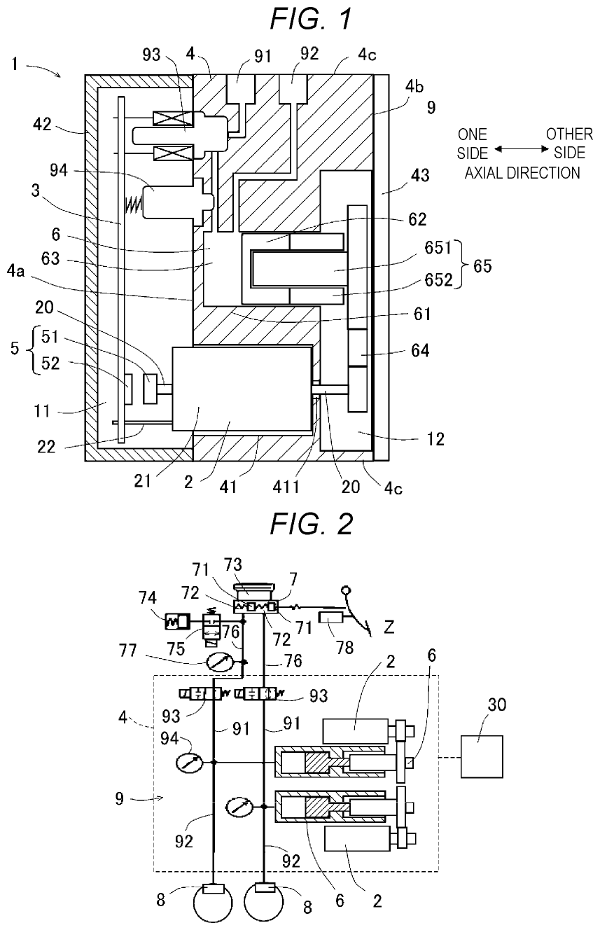

As shown in FIG. 1, a braking device 1 according to the present embodiment includes motors 2, a substrate 3, a housing 4, a rotation angle sensor 5, and electric cylinders 6. The motor 2 is a brushless motor. The motor 2 includes a rotary shaft 20, a main body portion 21 that rotates the rotary shaft 20, and a power terminal 22 for power reception that connects the main body portion 21 and the substrate 3. The rotary shaft 20 is an output shaft of the motor 2. Both end portions of the rotary shaft 20 protrude from the main body portion 21. In description of an installation position of the motor 2 according to the present disclosure, a position of the motor 2 means a position of the main body portion 21.

The main body portion 21 includes a winding, a stator, a rotor, and a case that houses the winding, the stator, and the rotor that are not shown. The power terminal 22 is implemented by a plurality of rod-shaped (shaft-shaped) conductors connected to the main body portion 21. The power terminal 22 is a portion protruding from the main body portion 21 for power reception. The power terminal 22 (a base end portion of the power terminal 22, that is, an end portion on a main body portion 21 side) faces the substrate 3. The power terminal 22 protrudes from the main body portion 21 toward the substrate 3 without the housing 4 interposed therebetween. The power terminal 22 is connected to a circuit formed on the substrate 3. Electric power is transmitted from the substrate 3 to the main body portion 21 via the power terminal 22. The motor 2 can adjust a braking force applied to wheels in accordance with rotation of the rotary shaft 20. The power terminal 22 may be connected to the substrate 3 via a wiring portion (harness).

The substrate 3 is a circuit board (ECU substrate) constituting a brake electronic control unit (ECU) 30. For example, a CPU and a memory are disposed on the substrate 3. The substrate 3 mainly controls the motor 2 and electronic components disposed in hydraulic circuits 9 to be described later. The substrate 3 is orthogonal to an extending direction (also referred to as an axial direction or a longitudinal direction) of the power terminal 22, and is connected to the power terminal 22.

The motor 2 is provided in the housing 4 such that an axial direction of the rotary shaft 20 is orthogonal to the substrate 3. The motor 2 is provided between the housing 4 and the substrate 3 such that the power terminal 22 faces the substrate 3, and is provided in the housing 4. In the following description, in the axial direction of the rotary shaft 20, a direction from the main body portion 21 toward the substrate 3 is referred to as “one axial side”, and a direction opposite thereto is referred to as “the other axial side”. The motor 2 is disposed on one axial side from a second surface 4b of the housing 4 except for the other end portion of the rotary shaft 20 in the axial direction.

The housing 4 is provided at a position facing the substrate 3. The housing 4 is a metal block provided with the hydraulic circuits 9. The housing 4 is formed in a polyhedral shape (for example, a rectangular parallelepiped shape) and has a plurality of surfaces. Specifically, the housing 4 has a first surface 4a facing the substrate 3, the second surface 4b which is a surface opposite to the first surface 4a (a back-to-back surface), and a plurality of side surfaces 4c that connect the two surfaces 4a and 4b. It can be said that the first surface 4a is one end surface of the housing 4 in the axial direction, and the second surface 4b is the other end surface of the housing 4 in the axial direction. The first surface 4a and the substrate 3 are covered with a cover member 42. The cover member 42 is formed in a recessed shape. The second surface 4b is covered with a lid member 43.

The motor 2 is disposed in the first surface 4a. A recessed portion 41 in which the motor 2 is accommodated is formed in the first surface 4a. The recessed portion 41 has an opening on one axial side and a bottom surface on the other axial side. The bottom surface of the recessed portion 41 faces the substrate 3 via the motor 2. That is, it can be said that the bottom surface of the recessed portion 41 constitutes a part of the first surface 4a. In this way, the recessed portion 41 is formed in the housing 4, and the motor 2 is disposed in the recessed portion 41. A through hole 411 through which the rotary shaft 20 is inserted is formed in the bottom surface of the recessed portion 41. The motor 2 is fixed to the recessed portion 41 via, for example, an elastic member.

The rotation angle sensor 5 includes a detection target member 51 disposed at an end portion (one end portion in the axial direction) of the rotary shaft 20 on a substrate 3 side, and a detection member 52 that is disposed on the substrate 3 and detects a position of the detection target member 51. The rotation angle sensor 5 according to the present embodiment is a magneto resistive sensor (MR sensor). The detection target member 51 is fixed to one end surface of the rotary shaft 20 in the axial direction. The detection target member 51 includes a magnet. The detection member 52 is disposed at a position, on the substrate 3, facing the detection target member 51. The detection member 52 includes a sensor element. Similarly to the substrate 3, the rotation angle sensor 5 is disposed in a substrate accommodating chamber 11 (sealed space) defined by the cover member 42 and the first surface 4a.

The electric cylinder 6 includes a cylinder unit 61, a piston 62, an output chamber 63, a deceleration mechanism 64, and a linear motion conversion member 65. The cylinder unit 61 is implemented by a part of the housing 4 and is formed in a bottomed cylindrical shape having an opening on the other axial side and a bottom surface on one axial side. The cylinder unit 61 is implemented by a recessed portion formed in the second surface 4b of the housing 4.

The piston 62 is a member that adjusts the braking force by movement in the axial direction. The piston 62 is accommodated in the cylinder unit 61 in a manner of being slidable in the axial direction. The cylinder unit 61 and the piston 62 are parallel to the rotary shaft 20 of the motor 2. In other words, central axes of the cylinder unit 61 and the piston 62 are parallel to the rotary shaft 20. The piston 62 is formed in a bottomed cylindrical shape having an opening on the other axial side and a bottom surface on one axial side.

The output chamber 63 is defined by the cylinder unit 61 and the piston 62. The output chamber 63 is defined in the cylinder unit 61. A volume of the output chamber 63 increases and decreases in accordance with the movement of the piston 62. That is, the volume of the output chamber 63 decreases as the piston 62 moves toward one axial side, and increases as the piston 62 moves toward the other axial side. The output chamber 63 is pressurized and depressurized in accordance with the movement of the piston 62.

The deceleration mechanism 64 is a mechanism that decelerates the rotation of the rotary shaft 20. The deceleration mechanism 64 includes a plurality of gears. The deceleration mechanism 64 connects the rotary shaft 20 of the motor 2 and a screw shaft 651 of the linear motion conversion member 65 by the plurality of gears. The deceleration mechanism 64 decelerates the rotation of the rotary shaft 20 and transmits the decelerated rotation to the linear motion conversion member 65. The detection target member 51 is fixed to one end portion of the rotary shaft 20 in the axial direction, and the gears of the deceleration mechanism 64 are fixed to the other end portion of the rotary shaft in the axial direction.

The linear motion conversion member 65 is a member that converts a rotational motion of the rotary shaft 20 transmitted via the deceleration mechanism 64 into a linear motion (motion in the axial direction) of the piston 62. The linear motion conversion member 65 is, for example, a ball screw mechanism, and includes the screw shaft 651, a nut 652 disposed on an outer peripheral side of the screw shaft 651, and balls (not shown). The screw shaft 651 and the nut 652 mesh with each other via the balls.

The screw shaft 651 is a rod-shaped member, and a groove (not shown) in which the balls can roll is formed in an outer peripheral surface of the screw shaft 651. The rotation of the rotary shaft 20 is transmitted to the screw shaft 651 via the deceleration mechanism 64. Therefore, the screw shaft 651 rotates in accordance with the rotation of the rotary shaft 20. A groove (not shown) in which the balls can roll is formed in an inner peripheral surface of the nut 652.

The balls are disposed between the groove of the screw shaft 651 and the groove of the nut 652. The nut 652 moves in the axial direction in accordance with rotation of the screw shaft 651. The piston 62 is disposed on one axial side of the nut 652. The piston 62 moves in the axial direction in accordance with the movement of the nut 652 in the axial direction.

As shown in FIGS. 1 and 2, first liquid passages 91 each connecting the output chamber 63 and a master cylinder 7 and second liquid passages 92 each connecting the output chamber 63 and a wheel cylinder 8 are formed in the housing 4. An electromagnetic valve 93 functioning as a master cut valve is disposed in the first liquid passage 91. The electromagnetic valve 93 is disposed in a recessed portion formed in the first surface 4a of the housing 4, and a part thereof protrudes from the first surface 4a toward the substrate 3 side. A connection terminal of the electromagnetic valve 93 is connected to the circuit of the substrate 3.

A pressure sensor 94 is disposed in the first liquid passage 91 (or the second liquid passage 92). The pressure sensor 94 detects hydraulic pressure in the output chamber 63. The pressure sensor 94 is disposed in a recessed portion formed in the first surface 4a of the housing 4, and a part thereof protrudes from the first surface 4a toward the substrate 3 side. A connection terminal (spring-shaped terminal) of the pressure sensor 94 is connected to the circuit of the substrate 3.

As described above, the hydraulic circuit 9 includes the electric cylinder 6 configured such that the volume of the output chamber 63 increases and decreases by the movement of the piston 62, the first liquid passage 91 connecting the output chamber 63 and the master cylinder 7, the second liquid passage 92 connecting the output chamber 63 and the wheel cylinder 8, and the electromagnetic valve 93 and the pressure sensor 94 which are disposed in the first liquid passage 91. Although the second liquid passage 92 is shown close to the piston 62 in the drawings, the second liquid passage 92 is connected to one end portion of the output chamber 63 in the axial direction.

As shown in FIG. 2, in the present example, two hydraulic circuits 9 are provided in the housing 4. The hydraulic circuits 9 are disposed between the master cylinder 7 and the wheel cylinders 8. The master cylinder 7 is a tandem master cylinder, and includes two pistons 71 that move in accordance with an operation of a brake operation member Z. The pistons 71 are biased toward an initial position by a biasing member. Two master chambers 72 defined by the two pistons 71 are defined inside the master cylinder 7. Volumes of the master chambers 72 increase and decrease in accordance with the movement of the pistons 71. The master cylinder 7 is configured such that the two master chambers 72 have the same pressure.

A reservoir 73 in which a brake liquid is stored is connected to the master chambers 72. A communication state between the master chambers 72 and the reservoir 73 is blocked by the movement of the pistons 71 from the initial position by a predetermined amount. A stroke simulator 74 is connected to one of the master chambers 72 (the master chamber 72 farther from the brake operation member Z). A simulator cut valve 75 is disposed between the master chamber 72 and the stroke simulator 74. The stroke simulator 74 is a device that generates a reaction force (reaction force pressure) in response to a brake operation. The simulator cut valve 75 is a normally closed electromagnetic valve, and is open at time of normal control (normal time).

The master cylinder 7 (master chambers 72) is connected to the first liquid passages 91 of the hydraulic circuits 9 via liquid passages 76. A pressure sensor 77 that detects hydraulic pressure in the master chamber 72 is connected to one of the liquid passages 76. The liquid passages 76, the pressure sensor 77, and/or the master cylinder 7 may be provided in the housing 4 similarly to the hydraulic circuits 9.

The wheel cylinders 8 are connected to the second liquid passages 92 of the hydraulic circuits 9. As hydraulic pressure in the wheel cylinders 8 increases, the braking force applied to the wheels increases. One wheel cylinder 8 is provided, for example, on a right front wheel, and the other wheel cylinder 8 is provided, for example, on a left front wheel. In this case, the braking device 1 applies a hydraulic braking force to the front wheels. The braking device 1 may be connected to rear wheels or front and rear wheels.

During the normal control, the electromagnetic valves 93 are closed, and the simulator cut valve 75 is opened. When the brake operation member Z is operated, the brake ECU 30 sets a target wheel pressure based on detection values of a stroke sensor 78 and the pressure sensor 77. The brake ECU 30 controls the motor 2 and controls the electric cylinder 6 based on the target wheel pressure and the detection value of the pressure sensor 94.

When the pistons 62 of the electric cylinders 6 move toward one axial side, the volumes of the output chambers 63 decrease, and the brake liquid is supplied from the output chambers 63 to the wheel cylinders 8 via the second liquid passages 92. That is, the output chambers 63 and the wheel cylinders 8 are pressurized. When the pistons 62 move toward the other axial side, the volumes of the output chambers 63 increase, and the output chambers 63 and the wheel cylinders 8 are decompressed. For example, when an abnormality such as a power failure occurs, the electromagnetic valves 93, which are normally open electromagnetic valves, are opened, and the simulator cut valve 75, which is a normally closed electromagnetic valve, is closed. Accordingly, the brake liquid is supplied from the master cylinder 7 to the wheel cylinders 8 in accordance with the operation of the brake operation member Z.

(Effects of Present Embodiment)

According to the present embodiment, the motor 2 is provided in the housing 4 in a manner of facing the substrate 3. Accordingly, the motor 2 and the substrate 3 can be connected to each other without forming a through hole for harness in the housing 4. That is, according to the present embodiment, since the power terminal 22 and the substrate 3 can be connected regardless of a size of the housing 4, a connection line between the motor 2 and the substrate 3 can be shortened. In addition, since the power terminal 22 is connected to the substrate 3 without passing through the through hole and the substrate 3 is orthogonal to the power terminal 22, a connection configuration is simplified. Accordingly, assembly workability can be improved.

Since the motor 2 is disposed in the recessed portion 41 formed in the housing 4, the braking device 1 can be miniaturized and heat dissipation of the motor 2 can be improved. The housing 4 made of metal surrounds the periphery of the main body portion 21 of the motor 2, thereby promoting the heat dissipation of the main body portion 21.

The detection target member 51 of the rotation angle sensor 5 is fixed to one end portion of the rotary shaft 20 in the axial direction, and the detection member 52 is fixed to the substrate 3. Accordingly, a rotation angle (rotation position) of the motor 2 can be accurately detected. In addition, a sensor harness is not necessary, and it is not necessary to provide the through hole for harness in the housing 4. That is, the configuration can be simplified, a degree of freedom of layout can be improved, and the assembly workability can be improved.

Since the piston 62 of the electric cylinder 6 is disposed in parallel with the rotary shaft 20 of the motor 2, the braking device 1 can be miniaturized. Further, since the hydraulic circuit 9 is constituted by a small number of devices (the electric cylinder 6, the electromagnetic valve 93, and the pressure sensor 94), an increase in size of the housing 4 is prevented.

The electromagnetic valve 93 is disposed on the same surface (that is, the first surface 4a) as the surface of the housing 4 in which the motor 2 is disposed. Accordingly, the braking device 1 can be easily designed to be miniaturized as compared to a case in which the electromagnetic valve 93 and the motor 2 are disposed on different surfaces. The pressure sensor 94 is also disposed on the same surface as the surface in which the motor 2 is disposed. This also makes it possible to miniaturize the braking device 1.

The pressure sensor 94 is disposed away from the motor 2. In the present example, in the housing 4, the electric cylinder 6 is disposed between the motor 2 and the pressure sensor 94, and thus the motor 2 and the pressure sensor 94 are separated from each other. Accordingly, an influence of noise generated by driving of the motor 2 on the pressure sensor 94 can be prevented. In the present example, the electromagnetic valve 93 is also disposed away from the motor 2. A shield may be provided on the pressure sensor 94.

The first surface 4a of the housing 4 is covered with the cover member 42 fixed to the housing 4. Therefore, the substrate 3, the motor 2, the electromagnetic valve 93, and the pressure sensor 94 disposed on a first surface 4a side are covered by the cover member 42. Accordingly, the motor 2, the substrate 3, and the electronic components can be protected by one cover member (a member having a high sealing property).

In the present embodiment, as shown in FIG. 2, one motor 2 is assigned to one wheel cylinder 8. In the hydraulic circuits 9 of FIG. 2, the motor 2 can be miniaturized and the number of electromagnetic valves can be reduced. Therefore, by applying a configuration according to the present embodiment, the braking device can be miniaturized effectively.

In the present embodiment, the housing 4 is disposed between the deceleration mechanism 64 and the motor 2 (the main body portion 21). As shown in FIG. 1, the deceleration mechanism 64 is disposed not in the substrate accommodating chamber 11 (a space surrounded by the housing 4 and the cover member 42) but in a back chamber 12 surrounded by the housing 4 and the lid member 43. The motor 2 and the deceleration mechanism 64 face each other with the housing 4 interposed therebetween. Accordingly, there is no possibility that a lubricant applied to the deceleration mechanism 64, wear particles generated by an operation of the deceleration mechanism 64, or a brake liquid leaking from the output chamber 63 adheres to the substrate 3, and there is no need to separately provide a mechanism for protecting the substrate 3 from the lubricant applied to the deceleration mechanism 64, the wear particles generated by the operation of the deceleration mechanism 64, or the brake liquid leaking from the output chamber 63. It can be said that the housing 4 that defines the substrate accommodating chamber 11 and the back chamber 12 is disposed between the motor 2 and the deceleration mechanism 64.

(Others)

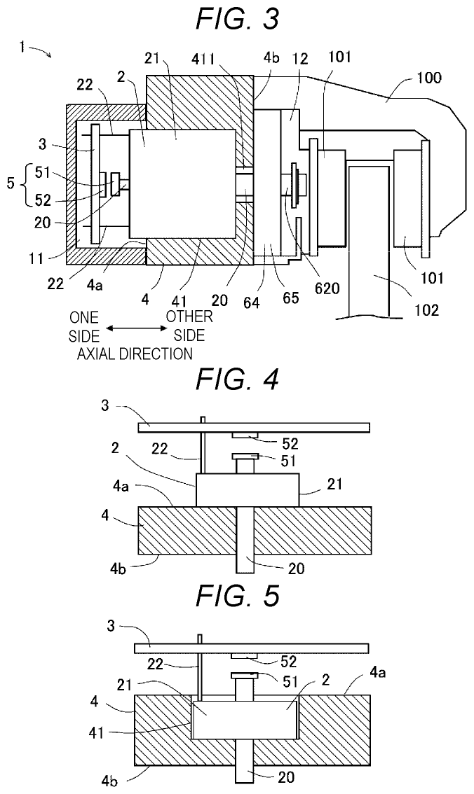

The disclosure is not limited to the above embodiment. For example, as shown in FIG. 3, the braking device 1 may be configured such that brake pads 101 are pressed against a disc rotor 102 by a direct pressing force generated by movement of a piston 620 instead of a hydraulic pressure force. In this configuration, the motor 2 is also disposed in the recessed portion 41 of the first surface 4a of the housing 4.

In an example of FIG. 3, the piston 620 is coaxially connected to the rotary shaft 20 via the deceleration mechanism 64 and the linear motion conversion member 65. That is, the piston 620 is disposed on the other axial side of the rotary shaft 20. The piston 620 moves in the axial direction in accordance with the rotation of the rotary shaft 20. By the movement of the piston 620 toward the other axial side, the piston 620 comes into contact with and presses one of the brake pads 101 of a caliper 100. With a configuration of the caliper 100, the two brake pads 101 sandwich the disc rotor 102, and a braking force due to friction is applied to the wheel. In this way, the piston is not limited to one constituting the electric cylinder 6, and may be configured to adjust the braking force by movement. In addition, from a viewpoint of miniaturization or a degree of freedom of layout, the piston is preferably disposed in parallel or coaxially with the rotary shaft 20.

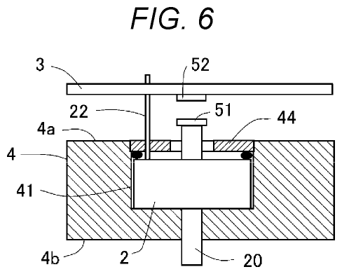

As shown in FIG. 4, the recessed portion 41 may not be provided in the first surface 4a, and the main body portion 21 of the motor 2 may be disposed on the first surface 4a. As shown in FIG. 5, the entire main body portion 21 of the motor 2 may be disposed in the recessed portion 41. It can be said that at least a part of the main body portion 21 is accommodated in the recessed portion 41. In addition, as shown in FIG. 6, the entire main body portion 21 may be disposed in the recessed portion 41, and the recessed portion 41 may be covered with the lid member 43. For example, the lid member 43 may be press-fitted into the recessed portion 41 so as to press the main body portion 21 toward the other axial side via an elastic member (for example, an O-ring). Accordingly, rattling of the motor 2 is prevented.

The rotation angle sensor 5 is not limited to the MR sensor, and may be, for example, an optical encoder or a resolver. The arrangements of the detection target member 51 and the detection member 52 are not limited to those in the above-described embodiment. For example, the detection member 52 may be disposed on an outer peripheral side of the rotary shaft 20. The deceleration mechanism 64 may not be provided. The linear motion conversion member 65 may have a configuration (for example, a configuration used in an electric parking brake) in which the ball screw is not used. The motor 2 may not be a brushless motor. In addition, the term “orthogonal” in the present disclosure includes a state in which a deviation occurs due to a manufacturing error or a tolerance (for example, 85 to 95 degrees). The same applies to the term “parallel” in the present disclosure.

1. A braking device comprising:
a motor including a power terminal for power reception and being configured to adjust a braking force applied to a wheel in accordance with rotation of a rotary shaft;
a substrate orthogonal to an extending direction of the power terminal and connected to the power terminal; and
a housing provided at a position facing the substrate, wherein
the motor is provided between the housing and the substrate such that the power terminal faces the substrate, and is provided in the housing.

2. The braking device according to claim 1, further comprising:
a deceleration mechanism configured to decelerate the rotation of the rotary shaft, wherein
the housing is disposed between the deceleration mechanism and the motor.

3. The braking device according to claim 2, wherein
a recessed portion is formed in the housing, and
the motor is provided in the recessed portion.

4. The braking device according to claim 3, wherein
the motor is a brushless motor, and is provided in the housing such that an axial direction of the rotary shaft is orthogonal to the substrate, and
the braking device further includes a rotation angle sensor including a detection target member disposed at an end portion of the rotary shaft on a substrate side and a detection member disposed on the substrate and configured to detect a position of the detection target member.

5. The braking device according to claim 4, further comprising:
a hydraulic circuit provided in the housing; and
a piston configured to adjust the braking force by movement, wherein
the hydraulic circuit includes
an electric cylinder configured such that a volume of an output chamber increases and decreases by the movement of the piston,
a first liquid passage that connects the output chamber and a master cylinder,
a second liquid passage that connects the output chamber and a wheel cylinder,
an electromagnetic valve disposed in the first liquid passage, and
a pressure sensor disposed in the first liquid passage.

6. The braking device according to claim 1, wherein a recessed portion is formed in the housing, and the motor is provided in the recessed portion.

7. The braking device according to claim 6, wherein
the motor is a brushless motor, and is provided in the housing such that an axial direction of the rotary shaft is orthogonal to the substrate, and
the braking device further includes a rotation angle sensor including a detection target member disposed at an end portion of the rotary shaft on a substrate side and a detection member disposed on the substrate and configured to detect a position of the detection target member.

8. The braking device according to claim 2, wherein
the motor is a brushless motor, and is provided in the housing such that an axial direction of the rotary shaft is orthogonal to the substrate, and
the braking device further includes a rotation angle sensor including a detection target member disposed at an end portion of the rotary shaft on a substrate side and a detection member disposed on the substrate and configured to detect a position of the detection target member.

9. The braking device according to claim 1, wherein
the motor is a brushless motor, and is provided in the housing such that an axial direction of the rotary shaft is orthogonal to the substrate, and
the braking device further includes a rotation angle sensor including a detection target member disposed at an end portion of the rotary shaft on a substrate side and a detection member disposed on the substrate and configured to detect a position of the detection target member.

10. The braking device according to claim 9, further comprising:
a hydraulic circuit provided in the housing; and
a piston configured to adjust the braking force by movement, wherein
the hydraulic circuit includes
an electric cylinder configured such that a volume of an output chamber increases and decreases by the movement of the piston,
a first liquid passage that connects the output chamber and a master cylinder,
a second liquid passage that connects the output chamber and a wheel cylinder,
an electromagnetic valve disposed in the first liquid passage, and
a pressure sensor disposed in the first liquid passage.

11. The braking device according to claim 8, further comprising:
a hydraulic circuit provided in the housing; and
a piston configured to adjust the braking force by movement, wherein
the hydraulic circuit includes
an electric cylinder configured such that a volume of an output chamber increases and decreases by the movement of the piston,
a first liquid passage that connects the output chamber and a master cylinder,
a second liquid passage that connects the output chamber and a wheel cylinder,
an electromagnetic valve disposed in the first liquid passage, and
a pressure sensor disposed in the first liquid passage.

12. The braking device according to claim 7, further comprising:
a hydraulic circuit provided in the housing; and
a piston configured to adjust the braking force by movement, wherein
the hydraulic circuit includes
an electric cylinder configured such that a volume of an output chamber increases and decreases by the movement of the piston,
a first liquid passage that connects the output chamber and a master cylinder,
a second liquid passage that connects the output chamber and a wheel cylinder,
an electromagnetic valve disposed in the first liquid passage, and
a pressure sensor disposed in the first liquid passage.

13. The braking device according to claim 6, further comprising:
a hydraulic circuit provided in the housing; and
a piston configured to adjust the braking force by movement, wherein
the hydraulic circuit includes
an electric cylinder configured such that a volume of an output chamber increases and decreases by the movement of the piston,
a first liquid passage that connects the output chamber and a master cylinder,
a second liquid passage that connects the output chamber and a wheel cylinder,
an electromagnetic valve disposed in the first liquid passage, and
a pressure sensor disposed in the first liquid passage.

14. The braking device according to claim 2, further comprising:
a hydraulic circuit provided in the housing; and
a piston configured to adjust the braking force by movement, wherein
the hydraulic circuit includes
an electric cylinder configured such that a volume of an output chamber increases and decreases by the movement of the piston,
a first liquid passage that connects the output chamber and a master cylinder,
a second liquid passage that connects the output chamber and a wheel cylinder,
an electromagnetic valve disposed in the first liquid passage, and
a pressure sensor disposed in the first liquid passage.

15. The braking device according to claim 1, further comprising:
a hydraulic circuit provided in the housing; and
a piston configured to adjust the braking force by movement, wherein
the hydraulic circuit includes
an electric cylinder configured such that a volume of an output chamber increases and decreases by the movement of the piston,
a first liquid passage that connects the output chamber and a master cylinder,
a second liquid passage that connects the output chamber and a wheel cylinder,
an electromagnetic valve disposed in the first liquid passage, and
a pressure sensor disposed in the first liquid passage.
